(19) United States
(12) Patent Application Publication
(10) Pub. No.: US 2024/0127465 A1
(43) Pub. Date: Apr. 18, 2024

(54) METHOD AND CALCULATION UNIT FOR ESTIMATING A DEPTH MAP FROM A DIGITAL HOLOGRAM, METHOD FOR CODING A VIDEO SEQUENCE, COMPUTER PROGRAM

(71) Applicant: FONDATION B-COM, CESSON SEVIGNE (FR)

(72) Inventors: Nabil MADALI, RENNES (FR); Antonin GILLES, RENNES (FR); Patrick GIOIA, SERVON-SUR-VILAINE (FR); Luce MORIN, RENNES (FR)

(21) Appl. No.: 18/483,989

(22) Filed: Oct. 10, 2023

(30) Foreign Application Priority Data
Oct. 11, 2022 (FR) 2210435

(51) Int. Cl. G06T 7/50; G03H 1/22; G06T 5/10

(52) U.S. Cl. CPC G06T 7/50; G03H 1/22; G06T 5/10; G06T 2207/20052

(57) ABSTRACT

Disclosed is a method, implemented by a calculation unit, for estimating a depth map from a digital hologram representing a scene, the method including: reconstructing, using the digital hologram, of n images of the scene, each associated with a depth of the scene and including multiple pixels, each image being defined by a same window; for each image, forming thumbnails composed of contiguous pixels and associated with two-dimensional regions of the window; applying an operator to each thumbnail of each image associated with a depth to provide a metric per thumbnail and by depth; determining a depth associated with each region two-dimensional based at least on the metrics relating to the thumbnails associated with the two-dimensional region concerned; determining the depth of a pixel of the depth map by selecting the depth having a maximum repetition number in the two-dimensional regions including the pixel concerned.

### CROSS-REFERENCE TO RELATED APPLICATIONS

This application claims the priority under 35 USC 119(a) of FR patent application 2210435 filed on Oct. 11, 2022, the entirety of which is incorporated herein by reference.

### BACKGROUND OF THE INVENTION

### Field of the Invention

The present invention relates to the technical field of digital holography.

It relates more particularly to a method for estimating a depth map from a digital hologram representing a scene. It also relates to a method for coding a video sequence using a motion vector from two digital holograms.

### Description of the Related Art

A digital hologram is the recording in digital form of a section, at a reference plane, of a light field propagating in a three-dimensional space, with a view to being able to subsequently restore this light field to a user.

We know methods for finding depth information in a digital hologram. These methods use methods for determining the depth from the plane of focus (known in particular under the English name “depth from focus”). These are configured to recover depth information from two-dimensional images using measurements of the degree of blur on these images. These methods are operational, but pose various problems, in particular precision and accuracy because in these methods several depths can be associated with the same pixel, causing errors in the choice of depth assigned to a pixel.

### SUMMARY OF THE INVENTION

In this context, the invention proposes a method, implemented by a calculation unit, for estimating a depth map from a digital hologram representing a scene, said method comprising:
a step of reconstructing, by means of said digital hologram, of n images of the scene, each image being associated with a depth of said scene and comprising a plurality of pixels, each image being defined by a same window;
for each image, a step of forming thumbnails composed of contiguous pixels and associated with two-dimensional regions of the window;
a step of applying an operator to each of the thumbnails of each image associated with a depth to provide a metric per thumbnail and per depth;
a step of determining a depth associated with each two-dimensional region on the basis of at least metrics relating to the thumbnails associated with the two-dimensional region concerned;
a step of determining the depth of a pixel of the depth map by selecting the depth having a maximum repetition number in the two-dimensional regions comprising the pixel concerned.

Thanks to the invention, the method provides a solution which makes it possible to avoid depth redundancies associated with a pixel. As a result, a single depth is assigned to each pixel at the output of the method according to the present disclosure. The depth map thus obtained is therefore more precise and fairer.

In one embodiment, the depth associated with each region is determined by selecting the depth for which the difference in absolute value between the metric relating to the two-dimensional region concerned and to the depth concerned on the one hand, and the average of the relative metrics to the two-dimensional region concerned on the other hand is maximum.

Thanks to this embodiment, the choice of the depth associated with the pixels of each two-dimensional region is less sensitive to «scab noise» or speckle noise (known under the English name “speckle”) and proving to be induced in the reconstruction step. Additionally, the choice of depth associated with the pixels in each two-dimensional region is also less sensitive to the blurring present in the thumbnails that can be caused by a shallow depth of field in the digital hologram. Such characteristics thus make it possible to obtain an even more precise and accurate depth map. The performance of the depth map estimation is therefore improved.

In another embodiment, the window of n images has a first main dimension and a second main dimension and each thumbnail has a first secondary dimension and a second secondary dimension, said first secondary dimension, respectively said second secondary dimension, depending on the first main dimension, respectively on the second main dimension, by a reduction factor.

According to a possible example, the reduction factor is between 61 and 32.

According to yet another example, each thumbnail is centered on at least one pixel.

In one embodiment, each thumbnail has a rectangular shape defined by the following formula:

$${R}_{i , m , n} ( u , v ) = {I}_{i} ( m + u - \frac{s 1}{2} , n + v - \frac{s 2}{2} )$$

with i corresponding to an index of an image, denoted I, associated with a depth of the n images, m and n corresponding to the coordinates of the pixel in the window, u and v corresponding to the coordinates of the pixel in the two-dimensional region associated with the thumbnail in which the pixel is centered, s1 corresponding to a first main dimension of the window associated with the image I with index i and s2 corresponding to a second main dimension of the window associated with image I with index i.

In a possible example, the first and second main dimensions are equal.

In one embodiment, the method comprises a step of determining a minimum depth and a maximum depth of said scene, the n images being spaced by a uniformly sampled distance in a defined interval between the maximum depth and the minimum depth of said scene.

In an exemplary embodiment, n is equal to 250.

In one embodiment, the operator applied in the application step is at least based on at least one of the following operators:
a gradient;
a Laplacian;
wavelets;
a Gabor transform;
statistics from information extracted from the n images or from the digital hologram;
a discrete cosine transform.

In one embodiment, the n images provided to the holographic reconstruction step are calculated using a propagation of the angular spectrum defined by the following formula:

$${I}_{i} = {F}^{- 1} \{ F ( H ) {e}^{j 2 π {z}_{i} \sqrt{{λ}^{- 2} - {f}_{x}^{2} - {f}_{y}^{2}}} \}$$

with F and F⁻¹ corresponding to direct and inverse Fourier transforms, respectively, and fₓ and f_{y} being the frequency coordinates of the digital hologram in the Fourier domain in a first spatial direction x and in a second spatial direction y of the digital hologram, λ being the acquisition wavelength, i being the index of the reconstructed image I with i ranging from 1 to n, zᵢ being the depth associated with the reconstructed image.

In one embodiment, the method further comprises a construction of a color image associating colorimetric information with a pixel of the depth map on the basis of the colorimetric information of the pixel concerned at the depth determined in the step of determining the depth of a pixel of the depth map.

The invention also proposes a method, implemented by a calculation unit, for estimating a depth map from a digital hologram representing a scene, said method comprising:
a reconstruction step, by means of said digital hologram, of n images of the scene, each image being associated with a depth of said scene and comprising a plurality of pixels, each image being defined by a same window;
for each image, a step of forming thumbnails composed of contiguous pixels and associated with two-dimensional regions of the window;
a step of applying an operator to each of the thumbnails of each image associated with a depth to provide a metric per thumbnail and per depth;
a step of determining a depth associated with each two-dimensional region by selection of the depth for which the difference in absolute value between the metric relating to the two-dimensional region concerned and the depth concerned on the one hand, and the average of the metrics relating to the two-dimensional region concernedon the other hand is maximum.

In one embodiment, the method further comprises a step of determining the depth of a pixel of the depth map by selecting the depth having a maximum repetition number in the two-dimensional regions comprising the pixel concerned.

The invention also proposes a method for coding a video sequence comprising at least a first digital hologram and at least a second digital hologram, said method comprising a step of estimating a first depth map from the first digital hologram as explained above and a step of estimating a second depth map from the second digital hologram as explained above, said method further comprising a step of determining a movement vector on the basis of the first and second depth maps.

In one embodiment, the method comprises:
a step of calculating a predicted hologram by applying said motion vector to the first hologram;
a step of calculating a residue per difference between the second hologram and the predicted hologram.

The invention also proposes a calculation unit for estimating a depth map from a digital hologram representing a scene, said calculation unit comprising:
a reconstruction module configured to reconstruct n images of said scene by means of said digital hologram, each image being associated with a depth of said scene and comprising a plurality of pixels, each image being defined by a same window;
a forming module configured to provide thumbnails composed of contiguous pixels from each image, said thumbnails being associated respectively with two-dimensional regions of the window;
an application module configured to apply an operator to each of the thumbnails of each image associated with a depth to provide a metric per thumbnail and per depth;
a depth determination module configured to determine a depth associated with each two-dimensional region;
a determination module configured to determine the depth of a pixel of the depth map by selecting the depth having a maximum repetition number in the two-dimensional regions comprising the pixel concerned.

In one embodiment, the determination module associated with each two-dimensional region is configured to select the depth for which the absolute value difference between the metric relating to the two-dimensional region concerned and the depth concerned on the one hand, and the average of the metrics relating to the two-dimensional region concerned on the other hand is maximum.

The invention also proposes a calculation unit for estimating a depth map from a digital hologram representing a scene, said calculation unit comprising:
a reconstruction module configured to reconstruct n images of said scene by means of said digital hologram, each image being associated with a depth of said scene and comprising a plurality of pixels, each image being defined by a same window;
a forming module configured to provide thumbnails composed of contiguous pixels from each image, said thumbnails being associated respectively with two-dimensional regions of the window;
an application module configured to apply an operator to each of the thumbnails of each image associated with a depth to provide a metric per thumbnail and per depth;
a depth determination module configured to determine a depth associated with each two-dimensional region by selecting the depth for which the difference in absolute value between the metric relating to the two-dimensional region concerned and the depth concerned on the one hand, and the average of the metrics relating to the two-dimensional region concerned on the other hand is maximum.

In one embodiment, the calculation unit further comprises a determination module configured to determine the depth of a pixel of the depth map by selecting the depth having a maximum repetition number in the two-dimensional regions comprising the pixel concerned.

The invention also proposes a computer program comprising instructions that can be executed by a processor and that are designed to implement a method as mentioned above when these instructions are executed by the processor, the aforementioned calculation unit being constituted for example by this processor.

The invention finally proposes a recording medium, possibly removable, readable by such a processor and memorizing such a computer program.

### BRIEF DESCRIPTION OF THE DRAWINGS

In addition, various other characteristics of the invention emerge from the appended description made with reference to the drawings which illustrate non-limiting forms of embodiment of the invention and where:

FIG. 1 is a schematic representation of an embodiment of a calculation unit for estimating a depth map from a digital hologram representing a scene;

FIG. 2 is a schematic representation of an embodiment of a calculation unit for coding a video sequence;

FIG. 3 is a schematic representation of an image obtained by a reconstruction module of the calculation unit illustrated in FIG. 1;

FIG. 4 is a schematic representation of an image cut by a forming module of the calculation unit illustrated in FIG. 1;

FIG. 5 is a schematic representation of a first embodiment of a method for estimating a depth map according to the present disclosure;

FIG. 6 is a schematic representation of the images obtained by a reconstruction step of the method according to the present disclosure;

FIG. 7 is a schematic representation of an embodiment of a method for coding a video sequence according to the present disclosure.

### DETAILED DESCRIPTION

### Device

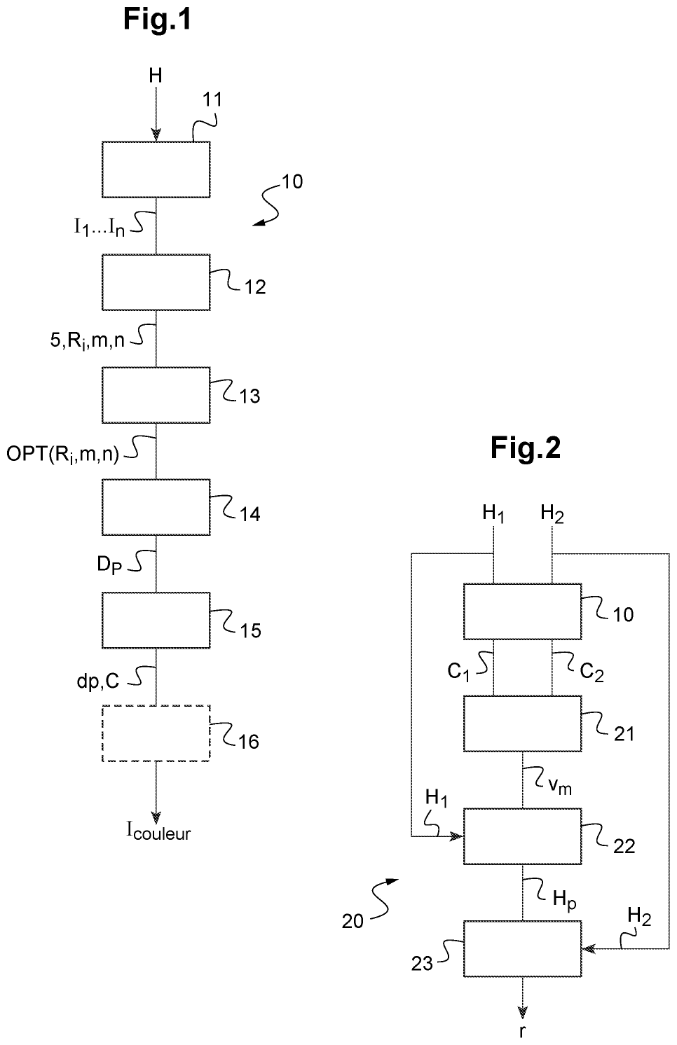

FIG. 1 illustrates an example of calculation unit 10 for estimating a depth map C from a digital hologram H according to the present disclosure.

By calculation unit 10 is meant any computer or processor or any other electronic element making it possible to implement a succession of commands and/or calculations. This calculation unit 10 typically comprises a processor, a memory and different input and output interfaces. In the example illustrated in FIG. 1, the input data of the calculation unit 10 comprise at least the digital hologram H and the output data of the calculation unit 10 comprise at least the estimated depth map C.

The calculation unit 10 illustrated in FIG. 1 comprises a reconstruction module 11, a forming module 12, an application module 13, a module 14 for determining a depth Dp, a module 15 for determining a depth dp at each pixel.

Each of these modules is for example implemented due to the execution, by the processor, of computer program instructions, which can be stored in the aforementioned memory. Alternatively, at least one of these modules can be implemented by means of a dedicated electronic circuit, such as a specific application integrated circuit.

According to the present disclosure, the digital hologram H representing a scene is received by the reconstruction module 11. In this example, the scene is a three-dimensional scene defined according to a reference frame (O, x, y, z) in which O represents the origin of the reference frame and x, y, z representing spatial directions of the digital hologram H with x being a first spatial direction of the digital hologram H, y being a second spatial direction of the digital hologram H, and z being a depth axis of the digital hologram.

In this example, the scene can include one object or multiple objects.

The digital hologram H in the present disclosure is defined by a matrix of pixels in a plane defined by the first and second spatial directions (x,y), the depth axis z being defined perpendicular to this plane. In the remainder of the description, the digital hologram H is defined in the plane of equation z=0. Each pixel of the digital hologram H typically represents a light wave received at this pixel.

The digital hologram H in the present disclosure was acquired with a wavelength λ in the visible, for example between 400 nm and 780 nm. In this example, the wavelength can be 550 nm.

Of course, in the present disclosure, several digital holograms acquired with several acquisition wavelengths and illustrating the same scene can be processed by the calculation unit 10. These different digital holograms will be processed as will be described below.

The reconstruction module 11 is configured to reconstruct n images Ii of the scene via the digital hologram H received, with i being an integer ranging from 1 to n.

The reconstructed images Ii can have several color spaces by reconstructing the images Ii from several digital holograms H acquired at different wavelengths (and illustrating the same scene). For this purpose, the reconstructed images Ii can be RGB images.

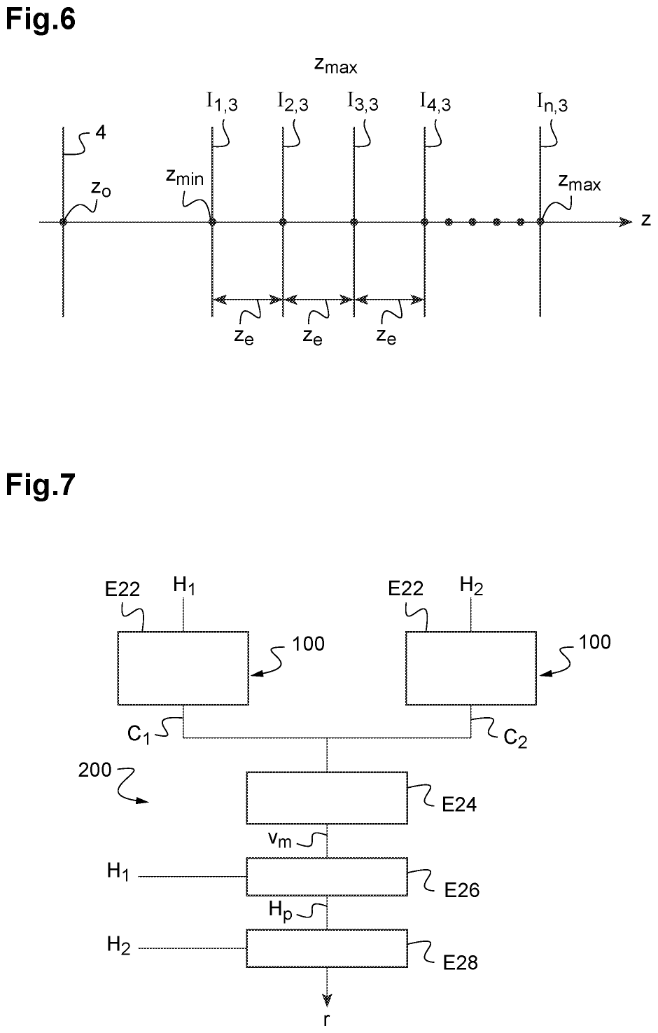

According to the present disclosure, each reconstructed image Ii is defined in a reconstruction plane which is perpendicular to the depth axis of the digital hologram H (along the z axis). Each reconstruction plane is associated with a depth value (as explained in FIG. 6), making it possible to associate with each reconstructed image Ii a depth zi, the index i referring to the index of the reconstructed image Ii.

Following this example, the reconstruction module 11 provides n images Ii of the scene, each being defined by a plurality of pixels. According to the present disclosure, the images Ii are all defined by a same window 2, thus making it possible to obtain images Ii of the same size.

In the remainder of the description, window 2 is represented by a two-dimensional plane defined by the first and second spatial directions (x, y). In the present disclosure, window 2 is defined by the set of pixels 1 of image Ii, which means that window 2 is of the size of image I1.

The reconstructed images are preferably made up of as many pixels as the digital hologram H. Thus, the reconstructed images Ii and the digital hologram H are of the same size.

Each image (I1 to In) provided by the reconstruction module 11 is associated with a depth denoted zi, with i corresponding to the index associated with the image Ii of the scene. In the present disclosure, the reconstruction module 11 is configured to reconstruct at least 2 images. For example, 250 images are reconstructed by the reconstruction module 11 from the digital hologram H. These 250 images will each be associated with a depth zi. Of course, in other embodiments, more images or fewer images can be reconstructed by the reconstruction module 11.

In the following text, two-dimensional regions R of the aforementioned window 2 are used. These two-dimensional regions R are for example rectangles included in window 2. The two-dimensional regions R consist of a fixed number of contiguous pixels of the image Ii. All reconstructed images Ii have the same two-dimensional regions R, which means that the two-dimensional regions R of the image I1 will be identical to the two-dimensional regions R of the image I2, I3, . . . In. Furthermore, according to the present disclosure, the two-dimensional regions R can overlap. This means that each pixel of a given image Ii can belong to several two-dimensional regions R. The overlap of the two-dimensional regions R in the reconstructed images improves the accuracy of the depth map estimation. For example, certain pixels may belong to at least two two-dimensional regions.

The images Ii are then transmitted to the forming module 12. According to the present disclosure, for each image Ii, the forming module 12 is configured to form a thumbnail 5 for each two-dimensional region R of the given image. The thumbnails 5 are constituted by contiguous pixels 1 of each image Ii. Thus, the forming module 12 is configured to cut each image Ii into thumbnails 5 made of contiguous pixels belonging to the same image Ii. In the present disclosure, the thumbnails 5 are respectively associated with two-dimensional regions R of the window 2, which means that the pixels 1 of each thumbnail 5 define a two-dimensional region R.

In this example, the images Ii are all cut in the same way. Thus, the two-dimensional regions R of the image I1 will be similar to the two-dimensional regions of the image I2, or I3, or etc. This is because the two-dimensional regions R of each image Ii are constituted of pixels with similar spatial coordinates in the images Ii.

The thumbnails 5 are then transmitted to the application module 13. The application module 13 is configured to apply an OPT operator to each one of the thumbnails 5. This OPT operator is applied to each one of the thumbnails 5 of each image Ii associated with a depth z, here 250 images, to provide a metric per thumbnail 5 and per depth (associated with each reconstruction plane 3).

From the thumbnails 5 and the metric associated with each thumbnail 5, the depth determination module 14 is configured to determine a depth Dp associated with each two-dimensional region R.

For this, the module 14 for determining a depth associated with each two-dimensional region R is configured to select the depth Dp for which the difference in absolute value between the metric relating to the two-dimensional region R concerned and the depth concerned on the one hand, and the average of the metrics relating to the two-dimensional region R concerned on the other hand is maximum. As a result, the depth Dp assigned to each two-dimensional region R is thus less sensitive to speckle or speckle noise and blur, making it possible to more accurately select the depth dp assigned to all pixels of the same two-dimensional region R. Such a characteristic makes it possible to obtain an even more precise and fairer depth map C at the output of the calculation unit 10.

The depth Dp determined by the determination module 14 is recorded for each two-dimensional region R.

From the depth Dp associated with each two-dimensional region R, the determination module 15 is configured to determine the depth dp of a pixel 1 of the depth map C.

For this, the determination module 15 is configured to evaluate the repetition of the depth Dp by looking at all two-dimensional regions which comprise the pixel concerned. The depth Dp having the maximum repetition number in these regions is selected as the depth dp associated with this pixel.

The determination module 15 is then configured to repeat this action for all pixels of window 2. Thus, a depth dp is individually assigned to each pixel 1 of window 2. A depth map C can thus be obtained at the output of the determination module 15 when a depth value dp has been assigned to all the pixels 1 of the depth map C.

In the present disclosure, the depth map C is defined by a matrix of pixels in a plane defined by the first and second spatial directions (x, y). The depth map C is in particular defined by all pixels of window 2 and the pixels of the digital hologram H. Each pixel of the depth map C has an intensity value which depends on the depth dp associated with the pixel concerned.

The calculation unit 10 according to the present disclosure makes it possible to obtain a depth map C in which a single and unique depth dp is assigned to each pixel 1 of the depth map C.

In the present disclosure, the depth map C obtained by the calculation unit 10 according to the present disclosure is therefore precise and fair.

Optionally, the calculation unit 10 further comprises a construction module 16 configured to construct a color image by associating, with a pixel of the depth map C, colorimetric information on the basis of the colorimetric information of the pixel concerned at the depth of this pixel in the depth map determined by the determination module 15, as will be described later in method 100. In this embodiment, a color image, denoted Icolor, can also be provided at the output of the calculation unit 10.

FIG. 2 illustrates another example of a calculation unit 20 according to the present disclosure. The calculation unit 20 includes the calculation unit 10 illustrated in FIG. 1. Thus, only the differences with FIG. 1 will be described. This calculation unit 20 typically comprises a processor, a memory and different input and output interfaces.

The calculation unit 20 illustrated in FIG. 2 receives a first digital hologram H1 and at least one second digital hologram H2. The first digital hologram H1 and the second digital hologram are sent to the calculation unit 10 in order to provide a first depth map C1 associated with the first digital hologram H1 and a second depth map C2 associated with the second digital hologram H2.

The calculation unit illustrated in FIG. 2 further comprises a module 21 for determining a movement vector vm on the basis of the first depth map C1 and second depth map C2. Thus, a movement vector vm is provided at the output of the determination module 21 as will be described later in method 200.

Optionally, the calculation unit 20 illustrated in FIG. 2 further comprises a prediction module 22 by application to the first digital hologram H1 of the motion vector vm (see method 200). In this case, the prediction module 22 receives the first digital hologram H1 and the motion vector vm calculated by the determination module 21 and provides the predicted hologram Hp.

In this embodiment, the calculation unit 20 also comprises in a non-limiting manner a calculation module 23 of a residue r. The residue calculation module 23 uses the second hologram H2 and the predicted hologram Hₚ to provide the residue r by the difference between the second hologram H2 and the predicted hologram Hₚ.

### Method

A first embodiment of a method 100 implemented by the processing unit 10 illustrated in FIG. 1 will be explained using FIGS. 2 to 6.

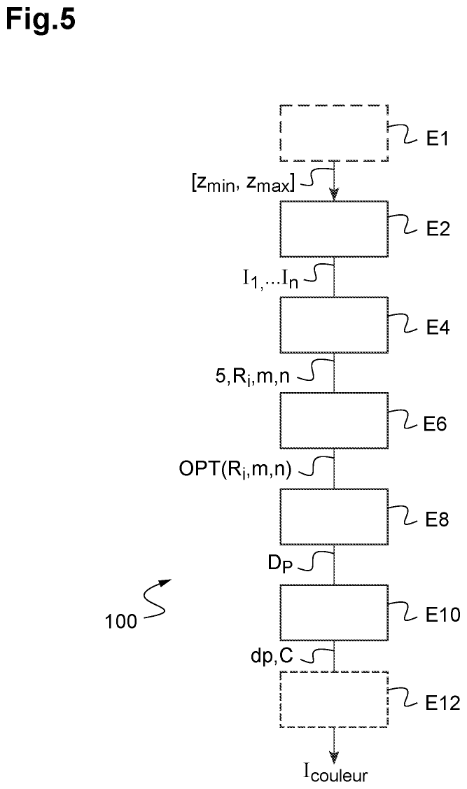

FIG. 5 illustrates an example of method 100 implemented by the calculation unit 10 illustrated in FIG. 1.

The method 100 illustrated in FIG. 5 comprises a reconstruction step E2, a forming step E4, an application step E6, a step E8 of determining a depth Dp associated with each two-dimensional region R and a step of determining the depth dp of a pixel.

In this example, the method 100 begins with a step E1 of determining a minimum depth zmin and a maximum depth zmax in the scene of the digital hologram H. This determination step E1 makes it possible to choose in a more effective way the number of images Ii reconstructed in the reconstruction step E2 as well as the distance ze separating each image Ii (that means the reconstruction plane 3 of each image Ii) (see below).

Optionally, if the reconstructed images Ii are color images (as explained in the description of the calculation unit 10), for example RGB, the reconstruction step E2 can include a gray level conversion of the reconstructed images Ii in order to optimize the implementation time of the following steps of the method 100. Of course, the colorimetric information of the reconstructed images Ii can be saved in the memory of the calculation unit 10 in order to be used subsequently in the method 100.

In one embodiment, the minimum depth zmin and the maximum depth zmax can be determined visually from the intensity associated with each pixel of the digital hologram H or from a query searching for the pixel having the maximum and minimum intensity. Of course, in another embodiment, the minimum depth zmin and the maximum depth zmax can be known beforehand.

The method 100 then comprises the step E2 of reconstruction, by the reconstruction module 11, of the n images Ii of the scene by means of the digital hologram H.

According to method 100, a succession of images Ii is obtained following the reconstruction step E2 (FIG. 6). Each image Ii is associated with a depth, denoted zi.

In this example, 250 images Ii are reconstructed. Thus, n is equal to 250. The number of reconstructed images Ii depends on the implementation time of the method 100 and a minimum number of images necessary to precisely estimate the depth map C.

Preferably, the n images provided at the holographic reconstruction step E2 are calculated using a propagation of the angular spectrum defined by the following formula:

$${I}_{i} = {F}^{- 1} \{ F ( H ) {e}^{j 2 π {z}_{i} \sqrt{{λ}^{- 2} - {f}_{x}^{2} - {f}_{y}^{2}}} \}$$

with F and F⁻¹ corresponding to direct and inverse Fourier transforms, respectively, and fₓ and f_{y} being the frequency coordinates of the digital hologram H in the Fourier domain in a first spatial direction x and in a second spatial direction y of the digital hologram, λ being the acquisition wavelength of the digital hologram H, i being the index of the image I reconstructed with i ranging from 1 to n, and zᵢ being the depth given in the reconstruction plane of the image Iᵢ.

FIG. 6 illustrates an example of a set of images Ii reconstructed in the reconstruction step E2 of the method 100 by means of the propagation of the angular spectrum.

In FIG. 6, the reconstructed images are located in a reconstruction plane 3 which is perpendicular to a depth axis (along the z axis). Each reconstruction plane 3 is associated with a depth value. This depth value defines a distance between plane 4 of the digital hologram H and the reconstruction plane 3. In this example, plane 4 of the digital hologram H is defined at the level of the light source used for the acquisition of the digital hologram H and thus has a zero reference position, denoted z0=0. Plane 4 of the digital hologram H is centered on the optical axis of the source used for the acquisition of the digital hologram H. Thus, in the example of FIG. 6, all images Ii are centered on the optical axis of the light source (which is defined on the spatial axis z) and are spaced by the same distance ze. The distance ze between each reconstruction plane 3 is similar and is, for example, 50 micrometers (μm).

Using the angular spectrum method thus makes it possible to obtain a succession of images Ii which are aligned on the optical axis of the light source used to acquire the digital hologram H.

In FIG. 6, the distance ze separating the images is determined from the maximum depth zmax and zmin, for example determined from determination step E1. Thus, the first reconstructed image I1 is spaced from plane 4 of the digital hologram H by the minimum depth zmin while the last reconstructed image In is spaced from plane 4 of the digital hologram H by the maximum depth zmax.

In another embodiment, the reconstruction step E2 carried out by the reconstruction module 11 uses the method described in the document “Angular spectrum-based wave-propagation method with compact space bandwidth for large propagation distances”, doi: 10.1364/OL.40.003420.

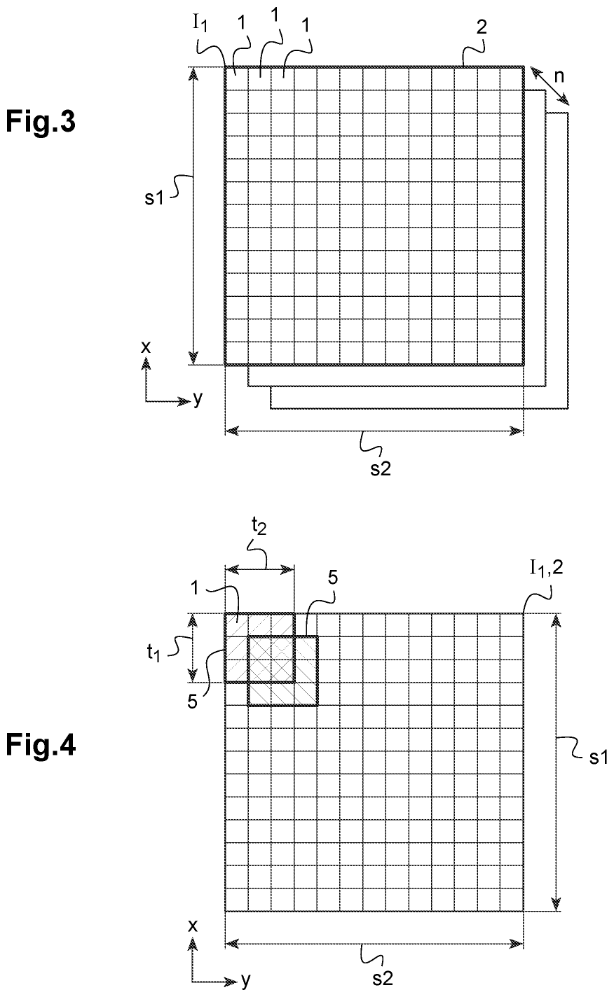

By way of example, FIG. 3 illustrates an example of an image obtained by the reconstruction module 11. In this example, the image, here the image I1, comprises a plurality of pixels 1. Each pixel 1 of the image considered, here I1, has a spatial position in the image considered I1 which is given by a line number m and column n in the corresponding image I1.

In FIG. 3, the image I1 is defined by the window 2 which is a function of the size of the image I1.

The image I1 illustrated in FIG. 3 also has a first main dimension, denoted s1, and a second main dimension, denoted s2.

In the example of FIG. 3, the image I1 is square in shape. The first principal dimension s1 is therefore perpendicular to the second principal dimension s2 and both are of the same size. In the method 100, the size of the images Ii depends on the size of the digital hologram H. Advantageously, the reconstructed images Ii in this example are of the size of the digital hologram H in order to retain all information contained in the digital hologram H.

In this example, the reconstruction module 11 illustrated in FIG. 1 reconstructs images Ii of similar size. Consequently, the windows 2 of the images Ii reconstructed by using the reconstruction module 11 are similar.

For example, the images Ii are of size 1024×1024 with pixels 1 of 6 micrometers (μm). These characteristics depend on the size of the sensor used to record the digital hologram H.

Of course, in the present disclosure, the reconstructed images Ii could be processed by different image processing techniques by the reconstruction module 11. When the reconstructed images Ii are color images (for example RGB images), the latter can be converted to gray level by techniques known to those skilled in the art, for example to implement step E6 with the local variance operator.

After the reconstruction step E2, the method 100 then comprises the step E4 of forming thumbnails 5 by the forming module 12. The thumbnails 5 determined by the forming module 12 are composed of contiguous pixels 1 from each image Ii. The thumbnails 5 are thus associated respectively with two-dimensional regions R of window 2.

By two-dimensional region R, we mean particular areas of the window 2 defined by the contiguous pixels constituting the thumbnail 5 considered. Thus, following this example, window 2 associated with a given image, for example image I1 of FIG. 4, is divided into a plurality of thumbnails 5.

In the example of FIG. 4, each thumbnail 5 of the image I1 is associated with a two-dimensional region R. Indeed, according to this embodiment, all images Ii are cut out in the same way. Thus, the two-dimensional region R of the thumbnail 5 comprising the pixels 1 of the first three columns and the first three lines of the image I1 is identical to the two-dimensional region R of the thumbnail 5 comprising the pixels of the first three columns and the three first lines of the image I2, or I3, or In. Such a characteristic facilitates the implementation of the method 100.

Optionally, each thumbnail 5 is centered on at least one pixel 1 of the pixels of said thumbnail 5. In the example of FIG. 4, the thumbnails 5 are centered on a pixel 1, which makes it possible to obtain two-dimensional regions R centered on a pixel 1. Such a configuration makes it possible to define a reference point at each thumbnail 5 of each image Ii. Of course, the two-dimensional regions R can overlap. This is due to the fact that the pixels can belong to several two-dimensional regions R. Preferably, the thumbnails are centered on a pixel having an optimal focus compared to a focus of a pixel adjacent to said pixel. Such a characteristic makes it possible to improve the performance of depth map estimation. By optimal focus of a pixel, we mean a pixel having a low level of noise (for example presenting no or little blur).

By way of example, each thumbnail 5 is subsequently identified from the two-dimensional region R with which it is associated and at the coordinates of pixel 1 on which it is centered. Thus, following this principle, each thumbnail 5 is illustrated by the following information Ri,n,m, with i being the index of the image associated with the thumbnail 5 and m and n corresponding to the coordinates of the pixel 1 on which the thumbnail 5 associated with the region Ri is centered. Therefore, the thumbnail 5 at the top left of the image I1 illustrated in FIG. 4 will be represented by the data R1,2,2.

In the example illustrated in FIG. 4, each thumbnail 5 has a first secondary dimension, denoted t1, and a second secondary dimension, denoted t2. The thumbnails 5 are preferably all of similar size, facilitating the implementation of the method 100.

In one embodiment of the method 100, each thumbnail 5 has a rectangular shape defined by the following formula:

$${R}_{i , m , n} ( u , v ) = {I}_{i} ( m + u - \frac{s 1}{2} , n + v - \frac{s 2}{2} )$$

with i corresponding to an index of an image, denoted I, associated with a depth, m and n corresponding to the coordinates of pixel 1 in the image Iᵢ on which the thumbnail 5 is centered in the window 2, u and v corresponding to the coordinates of the pixel in the two-dimensional region R associated with the thumbnail 5 in which the pixel is centered, s1 corresponding to a first main dimension of the window 2 associated with image I with index i and s2 corresponding to a second main dimension of the window associated with image I with index i.

Selecting thumbnails 5 having a size determined by the above formula makes it possible to adapt the precision of the depth map C. Indeed, choosing a thumbnail 5 size that is too small compared to the scene of the digital hologram H would cause an over-sampling of the thumbnails 5 of the images Ii and which could extend the implementation time of the method 100 and induce errors in the estimation of the depth map C. Conversely, taking thumbnails 5 of too large a size could induce undersampling of the thumbnails 5 images Ii. The depth map C obtained by method 100 could be less precise.

Advantageously, the size of the thumbnails 5 is adapted to the size of the image I1. In particular, the first secondary dimension t1 depends on the first main dimension s1 by a reduction factor and the second secondary dimension t2 depends on the second main dimension s2 by a reduction factor. Such a configuration makes it possible to improve the speed of implementation of the method 100 implemented by the calculation unit 10.

Preferably, the reduction factor associated with the first secondary dimension t1 is similar to the reduction factor associated with the second secondary dimension t2. This makes it possible to further improve the ease of implementation and the implementation time of the method.

Advantageously, the reduction factor associated with the first secondary dimension t1 is chosen between 61 and 32 and the reduction factor associated with the first secondary dimension t2 is chosen between 61 and 32. Such a configuration makes it possible to adapt the size of the thumbnails 5 to the objects in the scene, which improves the accuracy of the estimation of the depth map C.

According to one embodiment, the first main dimension s1 and the second main dimension s2 of the images Ii formed by the reconstruction module 11 are equal. Thus, this makes it possible to obtain thumbnails 5 and two-dimensional regions R of square shape. Such a configuration improves the ease of implementation of the method 100 while making it possible to obtain good results on the estimation of the depth map.

In one embodiment, the first and second secondary dimensions t1, t2 are similar. For example, the thumbnails 5 can thus have a size defined in number of pixels, for example 5 pixels×5 pixels (that is 5×5 pixels), or 9 pixels×9 pixels, or 13 pixels×13 pixels, or 17 pixels×17 pixels, or 21 pixels×21 pixels or 33 pixels×33 pixels with pixels of size between 1 μm to 15 μm, preferably equal to 6 μm.

According to this embodiment, a thumbnail size 5 of 13×13 pixels makes it possible to obtain a better estimate of the depth of the pixels positioned on the contours of areas or objects of the scene or on the corners and edges of the digital hologram H while the depth estimation on areas with small variations in depth and/or having little texture will be less efficient.

For thumbnails 5 of size greater than 13×13 pixels (with pixels of 6 μm), more depth information is included in these thumbnails 5 (because these thumbnails 5 are made up of more pixels 1), which allows to improve the estimation of the depth map. However, for thumbnails of size 33×33 pixels or larger than 33×33 pixels with pixels of 6 μm, too much depth information can be included in the thumbnails 5. Thus, there is a high probability of observing pixels having different depths and great variability (that means significant variation in depth) within the same thumbnail 5. In this embodiment, the choice of a single depth value Dp per thumbnail 5 in the determination step E8 could influence the step E10 of determining the depth of a pixel and therefore induce poor performance in the estimation of the depth map (see below).

Thus, the size of the thumbnails 5 influences the estimation of the depth map C. The latter is therefore chosen according to the scene of the digital hologram H.

In the example stated above, the pixels 1 of the images and of the digital hologram H are preferably 6 μm. However, identical results can be obtained for pixels from 1 to 15 μm. For example, the size of the thumbnails 5 given previously can be increased by a factor between 2 and 5 for pixels 1 less than 6 μm and reduced by a factor between 2 and 5 for pixels 1 greater than 6 μm.

The method illustrated in FIG. 5 then comprises a step E6 of application of the operator OPT to each of the thumbnails R of each image Ii associated with a depth zi to provide a metric per thumbnail 5 and per depth zi. The application step E6 is implemented by the application module 13.

In the following, the application of the OPT operator to all of the thumbnails 5 is represented by OPT(R i, n, m).

According to the present disclosure, several types of operators can be used. In a non-limiting manner, the operators used can be based on at least one of the following operators:
a gradient;
a Laplacian;
wavelets;
a Gabor transform;
statistics from information extracted from the n images or from the digital hologram H;
a discrete cosine transform.

The choice of the operator depends on the noise present on each thumbnail 5. Indeed, the speckle or speckle noise and/or the blur present on each thumbnail 5 influence(s) the choice of the OPT operator.

For example, the OPT operator based on the gradient is easy to implement and inexpensive in calculation time. However, this OPT operator can increase the blur of the thumbnails 5 and therefore induce errors or inaccuracies in the estimation of the depth map C. Consequently, this type of OPT operator is preferably selected when the average blur over all thumbnails 5 is low.

Preferably, the OPT operator based on statistics from information extracted on the n images or on the digital hologram H makes it possible to obtain better results in the selection of the depth assigned to each pixel (step E10), improving the precision of the method 100. As an example, the statistical operator used is the local variance operator of the intensity level on the n images, preferably the local gray level variance operator when the Ii images are in grayscale.

The application step E6 outputs a metric per thumbnail 5 and per depth. Thus, all thumbnails 5 of the different reconstruction planes 3 are associated with a metric.

The method 100 then comprises the step E8 of determining, by the module 14 for determining, the depth Dp associated with each two-dimensional region R on the basis of at least the metrics relating to the thumbnails 5 associated with the two-dimensional region concerned R.

Preferably, the determination step E8 of the method 100 works separately on each two-dimensional region R. Each two-dimensional region R is studied on all of the reconstruction planes 3. For this, the determination step E8 of the method 100 uses an optimization criterion which is applied individually to each two-dimensional region R positioned in the different reconstruction planes 3. This makes it possible to follow the evolution of the information contained in the two-dimensional region R given in the different reconstruction planes 3.

In this example, the optimization criterion is based on at least one of the following criteria:
argmin and calculated in this example according to the following formula:

Dp_{m,n}=argmin_{i=1, . . . n}OPT(R_{i,m,n})
argmax and calculated in this example by the following formula:

Dp_{m,n}=argmax_{i=1, . . . n}OPT(R_{i,m,n}),
with OPT(R_{i,m,n}) corresponding to the metric of a two-dimensional region R in the reconstruction plane 3 associated with a depth z with index i with i corresponding to the reconstruction image (thus giving the depth of the reconstruction plane 3), Dp_{m,n} corresponding to the depth assigned to the two-dimensional region R comprising the centering pixel with coordinates m, n in the image Iᵢ.

In the present disclosure, it is sought, for a given two-dimensional region R evolving in the different reconstruction planes 3, the depth zi for which the two-dimensional region R has the least speckle or speckle noise.

According to a first embodiment, such a depth zi can either correspond to:
an overall minimum reached by searching for example for the maximum intensity value of the pixel on which the two-dimensional region R given in the reconstruction planes 3 is centered with the argmin criterion, or
an overall maximum reached by searching for example the maximum intensity value of the pixel on which the two-dimensional region R given in the reconstruction planes 3 is centered with the criterion argmax.

Thus, according to this embodiment it is therefore necessary to check the variation of the metric in the different reconstruction planes 3 for each two-dimensional region R.

In a second embodiment, the depth Dp associated with each two-dimensional region R is determined by selection of the depth for which the difference in absolute value between the metric relating to the two-dimensional region R concerned and the depth concerned on the one hand, and the average, denoted μ, of the metrics pertaining to the two-dimensional region R concerned on the other hand is maximum.

According to this second embodiment, the depth Dp associated with each two-dimensional region R can be determined according to the following formula:

$$D {p}_{m , n} = arg {max}_{i = 1 … n} \vert μ - OPT ( {R}_{i , m , n} ) \vert avec μ = \frac{1}{n} {\sum }_{i} OPT ( {R}_{i , m , n} )$$

with μ being the average of the metric (result of application step E6 OPT(Ri, n, m)) of all two-dimensional regions R averaged over all reconstruction planes 3, OPT(R_{i,m,n}) corresponding to the metric of a two-dimensional region R in the reconstruction plane 3 associated with a depth z with index i with i corresponding to the reconstruction image (thus giving the depth of the reconstruction plane 3), | | being the absolute value operator, Dp_{m,n} corresponding to the depth assigned to the two-dimensional region R comprising the centering pixel with coordinates m, n.

The second embodiment thus makes it possible to simultaneously search for the global maxima and minima of the different two-dimensional regions R (here determined from the pixel on which the two-dimensional region R is centered). According to this second embodiment and for a given two-dimensional region R, it is no longer necessary to check the variation of the metric in the different reconstruction planes 3 to select the appropriate optimization criterion (argmin or argmax as described for the first embodiment), which makes it possible to improve the implementation time of the method 100. In addition, such a configuration also improves the precision and ease of implementation since only one type of optimization operator is used for the set of two-dimensional regions R.

Thus, following the determination step E8, all two-dimensional regions R are assigned a depth value Dp.

The method 100 then comprises the step E10 of determining the depth dp of a pixel 1 of the depth map C by selecting the depth Dp having a maximum repetition number in the two-dimensional regions R comprising the pixel 1 concerned. This determination step E10 makes it possible to assign to each pixel 1 its specific depth dp.

By way of example, the depth dp assigned to a pixel 1 in determination step E10 can be determined from the following formula:

$$d {p}_{m , n} = max ( A )$$

$$with A = count ( arg {max}_{i = 1 … n} \vert μ - OPT ( {R}_{i , m , n} ) \vert ) = ( {Dp}_{m , n} )$$

$$et μ = \frac{1}{n} {\sum }_{i} OPT ( {R}_{i , m , n} )$$

where count(Dp_{n,m}) corresponds to a function which is configured to count the number of occurrences of the value D_{n,m} associated with a pixel and max(A) to the function which returns the maximum number of occurrences of the value Dp_{m,n}.

In a first case, a given pixel 1 can have an identical depth value Dp in all two-dimensional regions R in which it is included.

In a second case, a given pixel 1 can have several depth values Dp over all of the two-dimensional regions R. This is particularly possible for pixels 1 belonging to several two-dimensional regions R.

According to this embodiment, for a given pixel, each time a two-dimensional region R contains this given pixel, the depth value Dp determined in the determination step E8 for this two-dimensional region R is recorded. The determination module 15 then counts the number of repetitions of the different depths Dp which have been assigned to all two-dimensional regions comprising the pixel concerned (previous determination step E8). Thus, the value Dp which has the greatest number of repetitions is selected to be the depth dp assigned to this pixel in the determination step E10. Therefore, for a given pixel, the depth value dp assigned to this pixel is the depth Dp which has been counted the greatest number of times.

The method 100 therefore makes it possible to process the pixels 1 individually to assign them a single and unique depth dp. The method 100 thus offers a solution that is easy to implement and inexpensive in terms of calculation time for precisely and reliably assigning a depth dp to a pixel in order to construct a depth map from the digital hologram H.

According to one embodiment of the method 100, the determination step E10 is preferably repeated for all pixels of the window. H. In this way, the method 100 provides a depth map C for which each pixel of the depth map C contains depth information. In this way, the depth map estimated via the method 100 can be considered as a two-dimensional representation of the 3D scene in which the columns and rows of the depth map C provide spatial information (for example, along the x and y axes), and the intensity value associated with each pixel gives information on the depth of this pixel (information oriented along the depth axis z).

Optionally, the method 100 comprises a step E12 of constructing a color image, denoted Icolor, by the construction module 16. The color image Icolor is determined using the depth map C provided at the end of the step of determination E10. For this, the construction module 16 associates colorimetric information with each pixel of the depth map C. This colorimetric information is determined using the colorimetric information of the pixel in the image Ii, that is to say in the reconstruction plane 3, associated with the depth value dp determined in the determination step E10.

In this way, the method 100 simply finds the colorimetric information from the depth map C and the information from the reconstructed images Ii in the reconstruction planes 3 at the depth dp.

The color image Icolor obtained at the end of the construction step E12 thus comprises in a first space the depth map C and in a second space a color image, for example in an RGB space. The color image Icolor thus obtained can be an RGB-D image.

Such an image Icolor thus makes it possible to describe the geometry of the scene as well as its depth. This image Icolor can thus be used in various applications, such as in the detection of three-dimensional movement which can be used for the compression of a holographic video.

A second example of a method 200 implemented by the processing unit 20 illustrated in FIG. 2 will be explained using FIG. 7.

The method 200 is a method of coding a video sequence. The method 200 illustrated in FIG. 7 uses a first digital hologram, denoted H1, and a second digital hologram, denoted H2. The first digital hologram H1 can present a scene at a given time and the second digital hologram H2 can illustrate the scene at a second given time, greater than the first time.

The method 200 thus comprises a step E22 of estimating a first depth map C1 from the first digital hologram H1 via the method 100 illustrated in FIG. 5. Such a step makes it possible to provide a first depth map C1 from the first digital hologram H1.

The method 200 also includes the step E22 of estimating a second depth map C2 from the second digital hologram H2 via the method 100 illustrated in FIG. 5. Such a step makes it possible to provide a second depth map C2 from the second digital hologram H2.

In this embodiment, the estimation steps E22 are carried out by the calculation unit 10 illustrated in FIG. 1.

After having obtained a depth map for each digital hologram H1, H2, the method 200 then comprises a step E24 of determining a movement vector vm on the basis of the first depth map C1 obtained from the first hologram H1 and on the basis of the second depth map C2 obtained from the second hologram H2. This movement vector vm is preferably determined by the determination module 21.

In a first embodiment, the method 100 used in steps E22 does not include a construction step E12. In this case, only a depth map associated with the first hologram H1 and a depth map associated with the second hologram H2 are therefore obtained following steps E22. The method 200 thus provides in this embodiment a movement vector vm in one dimension along the spatial depth dimension given along the depth axis z.

In a second embodiment, it is possible to obtain, by method 200, a movement vector vm having spatial components in three dimensions, that is to say on the x, y and z axes. In this case, the method 100 used in steps E22 comprises construction step E12. As a result, each step E22 is configured to provide, from the color image Icolor, a motion vector vm in two dimensions using the spatial components x and y extracted from the colorimetric space of the image color Icolor (e.g. RGB color space) and a motion vector vm on the spatial dimension of depth defined along the depth axis z and determined from the depth map C recorded in the space D of the image Icolor.

Optionally, the motion vector vm obtained in step E24 can be used to predict a digital hologram, denoted Hp.

According to this embodiment and in a non-limiting manner, the method 200 comprises, following the step E24 of determining the movement vector vm, a step E26 of calculating a predicted hologram Hp by the prediction module 22. In the example illustrated in FIG. 7, the predicted hologram Hp is obtained by application to the first hologram H1 of the motion vector vm determined in the determination step E24.

The method 200 then comprises a step E28 of calculating a residue r by difference between the second hologram H2 and the predicted hologram Hₚ calculated in the calculation step E26. In this example, the calculation step E28 is carried out by the calculation module 23 illustrated in FIG. 2.

1. Method, implemented by a calculation unit, for estimating a depth map from a digital hologram representing a scene, said method comprising:
reconstructing, using the digital hologram, n images of the scene, each of the images being associated with a depth of said scene and comprising a plurality of pixels, each of the images being defined by a same window;
for each image, forming thumbnails composed of contiguous said pixels and associated with two-dimensional regions of the window;
applying an operator to each of the thumbnails of each said image associated with a given said depth to provide a metric per said thumbnail and per said depth;
determining a depth associated with each said two-dimensional region on the basis of at least the metrics relating to the thumbnails associated with the two-dimensional region concerned;
determining a depth of a pixel-of the depth map by selecting the depth having a maximum repetition number in the two-dimensional regions comprising the pixel concerned.

2. The method according to claim 1, wherein the depth associated with each said region is determined by selection of the depth for which a difference in absolute value between
the metric relating to both the two-dimensional region concerned and the depth concerned, and
an average of the metrics relating to the two-dimensional region concerned on
is maximum.

3. The method according to claim 1, wherein the window of the n images has a first and a second main dimension and each of the thumbnails has a first and a second secondary dimension, said first and second secondary dimensions depending, on the first and second main dimensions, respectively, by a reduction factor.

4. The method according to claim 3, wherein the reduction factor is between 61 and 32.

5. The method according to claim 1, wherein each said thumbnail is centered on at least one said pixel.

6. The method according to claim 5 wherein each said thumbnail has a rectangular shape defined by the following formula:
$${R}_{i , m , n} ( u , v ) = {I}_{i} ( m + u - \frac{s 1}{2} , n + v - \frac{s 2}{2} )$$
with i corresponding to an index of a given said image, denoted I, associated with a given said depth of the n images, m and n corresponding to coordinates of a given said pixel in the window, u and v corresponding to coordinates of the given pixel in the two-dimensional region associated with the thumbnail in which the given pixel is centered, s1 corresponding to a first main dimension of the window associated with the image I with index i and s2 corresponding to a second main dimension of the window associated with the image I with index i.

7. The method according to claim 3, wherein the first and the second main dimension are equal.

8. The method according to claim 1, further comprising determining a minimum said depth and a maximum said depth of said scene, the n images being spaced by a distance sampled uniformly in a defined interval between the maximum and minimum depths of said scene.

9. The method according to claim 1, wherein n is equal to 250.

10. The method according to claim 1, wherein the operator is at least based on at least one of the following operators:
a gradient;
a Laplacian;
wavelets;
a Gabor transform;
statistics from information extracted from the n images or from the digital hologram;
a discrete cosine transform.

11. The method according to claim 1, wherein the n images on which the holographic reconstructing are performed are calculated using a propagation of an angular spectrum defined by the following formula:
$${I}_{i} = {F}^{- 1} \{ F ( H ) {e}^{j 2 π {z}_{i} \sqrt{{λ}^{- 2} - {f}_{x}^{2} - {f}_{y}^{2}}} \}$$
with F and F⁻¹ corresponding to direct and inverse Fourier transforms, respectively, and fₓ and f_{y} being frequency coordinates of the digital hologram in the Fourier domain in a first spatial direction x and in a second spatial direction y of the digital hologram, λ being acquisition wavelength, i being the index of the reconstructed image I with i ranging from 1 to n, zᵢ being the depth associated with the reconstructed image.

12. The method according to claim 1, wherein the method further comprises constructing a color image associating colorimetric information with a pixel of the depth map based on the colorimetric information of the pixel concerned at the depth determined in the step of determining the depth of a pixel of the depth map.

13. Method for coding a video sequence comprising at least a first digital hologram and at least a second digital hologram, of the method comprising:
estimating a first depth map from the first digital hologram according to the method of claim 1,
estimating a second depth map from the second digital hologram according to the method of claim 1, and
determining a motion vector based on the first and second depth maps.

14. The coding method according to claim 13, further comprising:
calculating a predicted hologram by applying said motion vector to the first hologram;
calculating a residue by difference between the second hologram and the predicted hologram.

15. A non-transitory computer-readable medium on which are stored instructions executable by a processor that cause the processor to implement the method according to claim 1 when these instructions are executed by the processor.

16. Calculation unit for estimating a depth map from a digital hologram representing a scene, said calculation unit comprising:
a reconstruction module configured to reconstruct n images of said scene using said digital hologram, each of the images being associated with a depth of said scene and comprising a plurality of pixels, each of the images being defined by a same window;
a forming module configured to provide thumbnails composed of contiguous said pixels from each of the images, said thumbnails being associated respectively with two-dimensional regions of the window;
an application module configured to apply an operator to each of the thumbnails of each said image associated with a given said depth to provide a metric per said thumbnail and per said depth;
a depth determination module configured to determine a depth associated with each said two-dimensional region;
a determination module configured to determine the depth of a given said pixel of the depth map by selecting the depth having a maximum repetition number in the two-dimensional regions comprising the pixel concerned.

17. The calculation unit according to claim 16, wherein the module for determining the depth associated with each said two-dimensional region is configured to select the depth for which the difference in absolute value between
the metric relating both to the two-dimensional region concerned and at the concerned depth, and
an average of the metrics relating to the two-dimensional region concerned
is maximum.

18. The method according to claim 2, wherein the window of then images has a first and a second main dimension and each of the thumbnails has a first and a second secondary dimension, said first and second secondary dimensions depending, on the first and second main dimensions, respectively, by a reduction factor.

19. The method according to claim 18, wherein each said thumbnail is centered on at least one said pixel.

20. The method according to claim 19, wherein each said thumbnail has a rectangular shape defined by the following formula:
$${R}_{i , m , n} = {I}_{i} ( m + u - \frac{s 1}{2} , n + v - \frac{s 2}{2} )$$
with i corresponding to an index of a given said image, denoted I, associated with a given said depth of the n images, m and n corresponding to coordinates of a given said pixel in the window, u and v corresponding to coordinates of the given pixel in the two-dimensional region associated with the thumbnail in which the given pixel is centered, s1 corresponding to a first main dimension of the window associated with the image I with index i and s2 corresponding to a second main dimension of the window associated with the image I with index i.
